(19) United States
(12) Patent Application Publication
(10) Pub. No.: US 2009/0266212 A1
(43) Pub. Date: Oct. 29, 2009

(54) Saw blade dismantling and positioning structure of sawing machine

(75) Inventor: Tian-Wang Wang, Taichung Hsien (TW)

Correspondence Address: Tian-Wang Wang, P.O. Box 44-2049, Taipei, 10668, TW

(73) Assignee: Mao Shan Machinery Industrial Co., Ltd.

(21) Appl. No.: 12/149,200

(22) Filed: Apr. 29, 2008

(51) Int. Cl. B26D 1/14

(52) U.S. Cl. 83/469

(57) ABSTRACT

The present invention provides a saw blade dismantling & positioning structure of sawing machine, whereby the push rod is snapped into the hole of the saw blade shaft disk for controlling the positioning of the rotating shaft and rapid dismantling the saw blade; a shaft disk is mounted onto the rotating shaft of the sawing machine, and at least a hole is preset laterally onto the shaft disk; a positioning device is assembled onto the lifting seat at the same side of the shaft disk; the pressure plate of the positioning device is driven so that the push rod is coupled and snapped into the hole of the shaft disk for controlling the positioning of rotating shaft, and rapid dismantling or assembly of the saw blade.

### BACKGROUND OF THE INVENTION

(1) Field of the Invention

The present invention relates generally to a saw blade dismantling and positioning structure of sawing machine, and more particularly to an innovative one which enables convenient positioning of shaft and dismantling or assembly of saw blade by mating the holes laterally on the shaft disk with the push rod of the positioning device.

(2) Description of the Prior Art

FIG. 6 depicts the assembly view of saw blade of conventional sawing machine, wherein a female nut 32 is embedded into the axle center 31 of the lifting seat 30, then the saw blade 33 is sleeved onto the axle center 31 for overlapping externally on the female nut 32, and finally the male nut 34 is locked into the axle center 31; with the mating of two nuts 32, 34, the saw blade 33 can be fixed on the sawing machine for cutting the timber. However, the following shortcomings are observed during years of actual applications:

Firstly: when the saw blade is to be replaced, the operator has to fix the axle center by holding the nuts with spanner, etc, and then screw loosely the male nut with another spanner. So, whenever it is intended to dismantle or assemble the saw blade, two tool kits are required for fixing and screwing the nuts, thus making it inconvenient for replacement.

Secondly: due to limited space of the axle center and saw blade, two tool kits may possibly collide with each other, and bring about the deformation or damage of axle center or nuts, thus affecting the operation process or quality.

Thirdly: if the saw blade is to be dismantled or assembled in the lack of auxiliary tool, the operator has to fix the axle center by manually pressing or holding the saw blade, and then loosening the male nuts, possibly leading to personal injury.

### SUMMARY OF THE INVENTION

The main objective of the present invention is to drive the push rod via a positioning device preset laterally onto the rotating shaft of saw blade, and then mate the push rod with the holes of the shaft disk, thus achieving rapid positioning of the rotating shaft.

Another objective of the present invention is to control the positioning of the rotating shaft via the positioning device, which not only improves inconvenient dismantling of saw blade for quick replacement, but also prevents any mechanical damage or personal injury from misoperation.

### BRIEF DESCRIPTION OF THE DRAWINGS

FIG. 1 depicts a relational view of the device of the present invention.

FIG. 2 depicts an exploded view of the device of the present invention.

FIG. 3 depicts a perspective view of the present invention.

FIG. 4 depicts an exploded view of the present invention.

FIG. 5 depicts an application view of the present invention.

FIG. 6 depicts a structural view of typical saw blade dismantling structure.

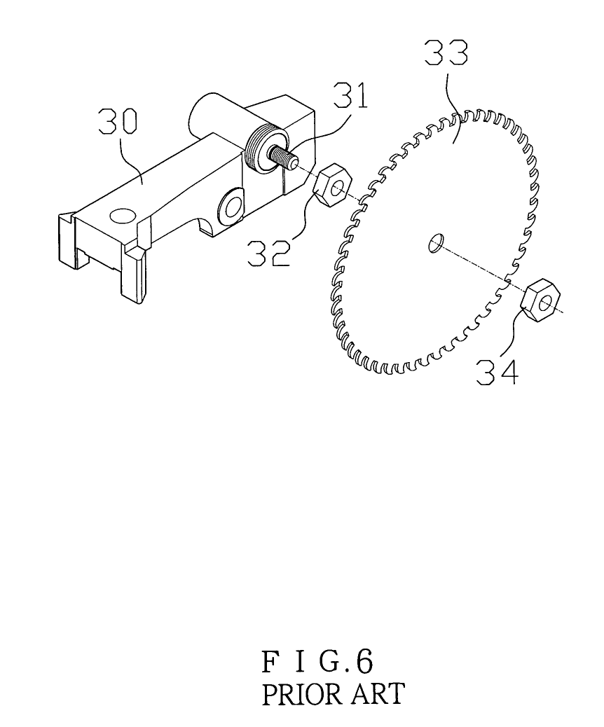

### DETAILED DESCRIPTION OF THE PREFERRED EMBODIMENTS

The structural composition of the present invention is described with reference to the accompanied drawings:

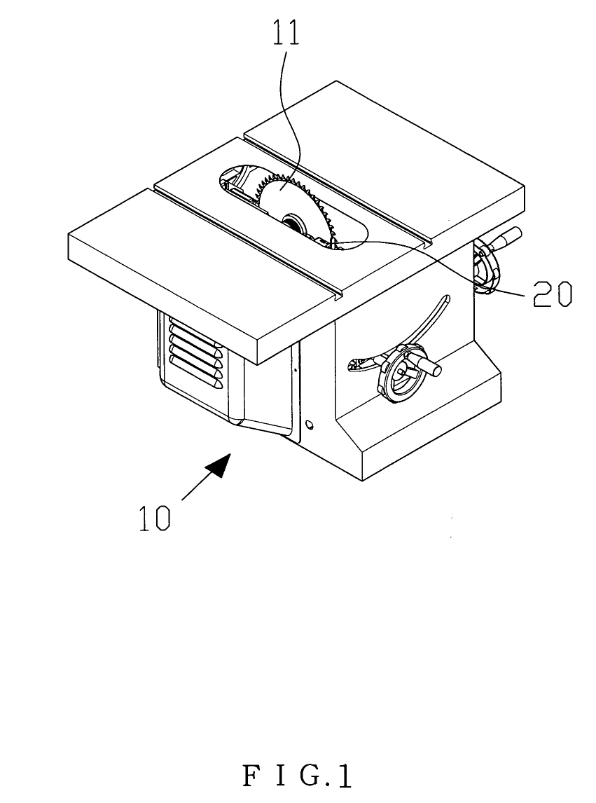

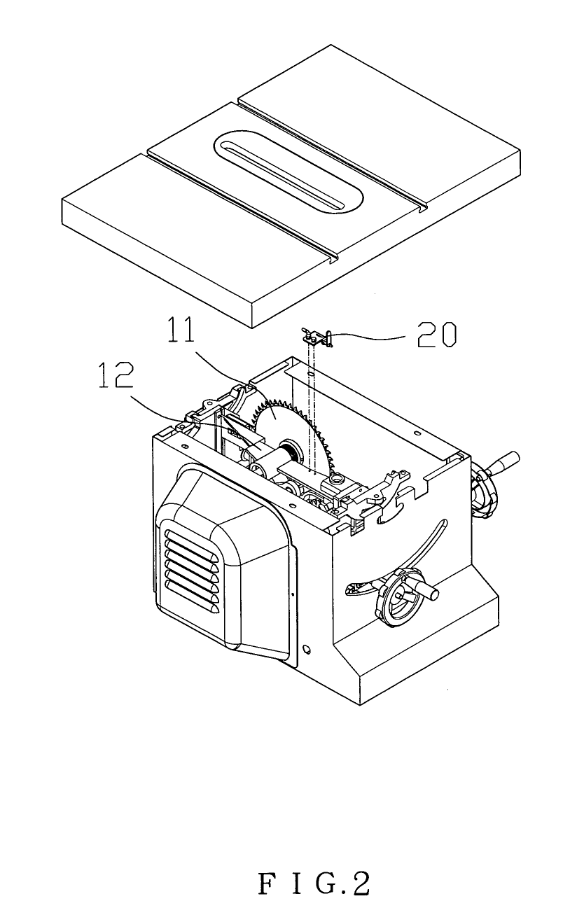

Referring firstly to FIG. 1 (relational view of the device) and FIG. 2 (exploded view of the device), the sawing machine 10 is provided with a lifting seat 12, one side of which is connected with a saw blade 11; a positioning device 20 is mounted onto the lifting seat 12.

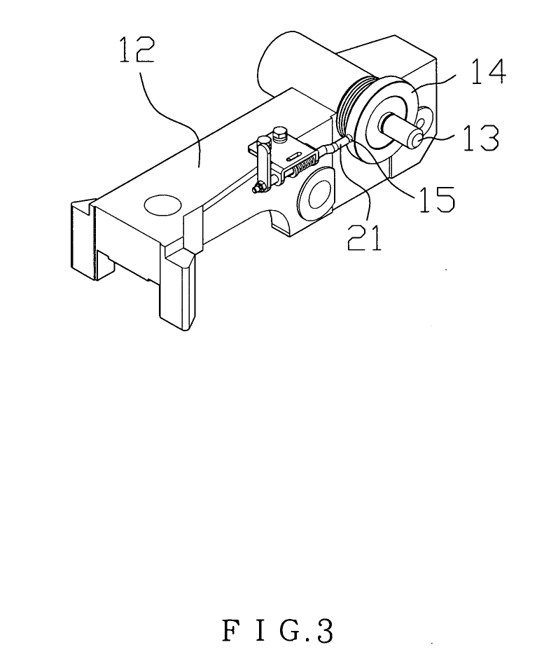

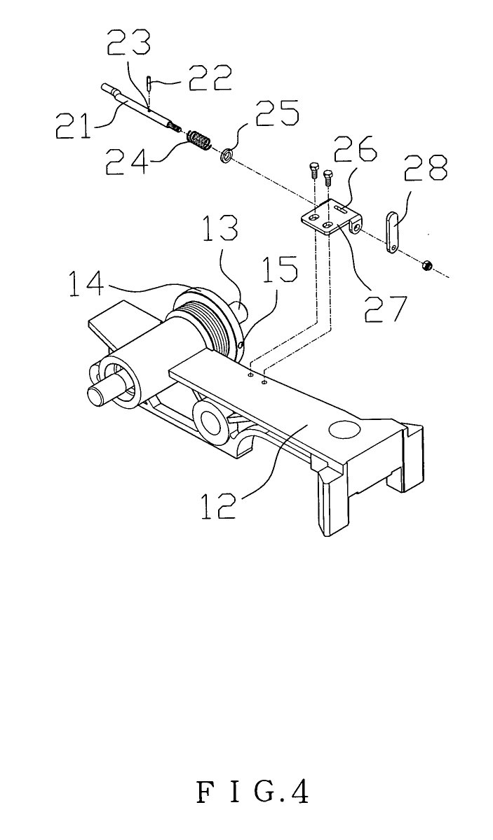

Referring also to FIG. 3 (perspective view) and FIG. 4 (exploded view), the lifting seat 12 is provided with a rotating shaft 13 protruding laterally; a shaft disk 14 is mounted onto the rotating shaft 13, and at least a hole 15 is laterally preset onto the shaft disk 14; moreover, the positioning device 20 is assembled onto the lifting seat 12 at the same side of the shaft disk 14; the positioning device 20 is structurally locked on the lifting seat 12 via a connecting base 27; the connecting base 27 is provided with a penetrated spacing hole 26; the push rod 21 is sleeved into restoring spring 24 and ring 25, then assembled at lower end of the connecting base 27, and inserted into the spacing hole 27 via a vertical rod 22 for mating with the hole 23 of the push rod 21, so that the restoring spring 24 may provide a flexible space to the push rod 21 via interlocking of ring 25, vertical rod 22 and spacing hole 26; a pressure plate 28 is mounted at rear side of the push rod 21 for convenient operation of the positioning device 20.

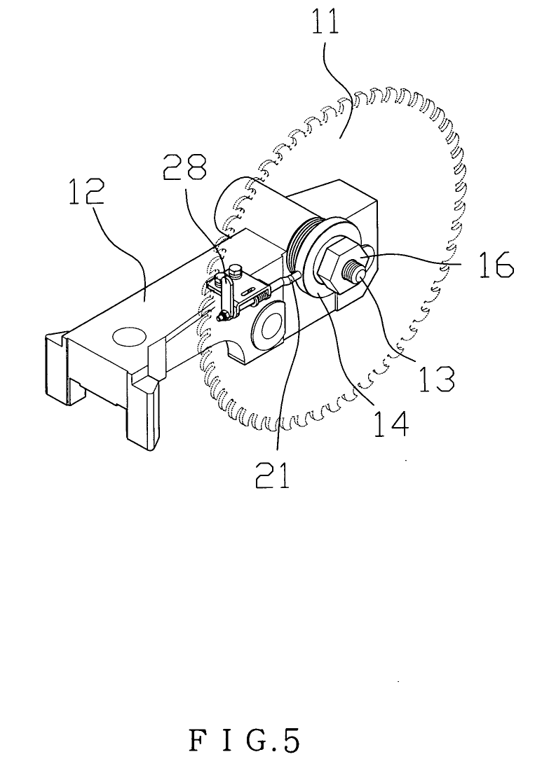

Referring also to FIG. 5, when the saw blade 11 is to be dismantled, the pressure plate 28 of the positioning device 20 is driven so that the push rod 21 is coupled and snapped into the hole 15 of the shaft disk 14 for controlling the positioning of rotating shaft 13; next, any auxiliary tool is used to screw loosely or tightly the nut 16 on the saw blade 11, thus realizing rapid dismantling or reassembly.

In sum, the improved saw blade dismantling & positioning structure of sawing machine of the present invention enables rapid positioning of rotating shaft and convenient dismantling of saw blade, and also eliminates the inconvenience and hazard of dismantling saw blade, so the utility model features outstanding and innovative design with excellent industrial applicability for patent claims.

What is claimed is:

1. A saw blade dismantling & positioning structure of sawing machine, comprising:
a shaft disk, located at rear side of the saw blade's rotating shaft on the lifting seat; at least a positioning hole preset laterally on the shaft disk;
a positioning device, located at one side of the shaft disk on the lifting seat, where a transverse push rod is driven by the pressure plate is placed;
by driving the pressure plate and transverse push rod, the push rod is snapped into any locating hole on the shaft disk for controlling the positioning of the shaft disk and rapid dismantling of the saw blade.

2. The structure defined in claim 1, wherein the number of locating hole on the shaft disk is added or reduced where necessary.
